(19) United States
(12) Patent Application Publication
(10) Pub. No.: US 2022/0114807 A1
(43) Pub. Date: Apr. 14, 2022

(54) OBJECT DETECTION USING MULTIPLE NEURAL NETWORKS TRAINED FOR DIFFERENT IMAGE FIELDS

(71) Applicant: Optimum Semiconductor Technologies Inc., Tarrytown, NY (US)

(72) Inventors: Sabin Daniel IANCU, Pleasantville, NY (US); Beinan WANG, White Plains, NY (US); John GLOSSNER, Nashua, NH (US)

(73) Assignee: Optimum Semiconductor Technologies Inc., Tarrytown, NY (US)

(21) Appl. No.: 17/264,146

(22) PCT Filed: Jul. 24, 2019
(86) PCT No.: PCT/US2019/043244

§ 371 Date: Jan. 28, 2021

Related U.S. Application Data
(60) Provisional application No. 62/711,695, filed on Jul. 30, 2018.

(51) Int. Cl. G06V 10/82; G06T 7/194; G06T 7/20; B60W 60/00; G06N 3/04; G06N 3/08

(52) U.S. Cl. CPC G06V 10/82; G06T 7/194; G06T 7/20; B60W 60/0027; B60W 2420/52; G06N 3/08; G06T 2207/10028; G06T 2207/30252; B60W 2420/42; G06N 3/0454

(57) ABSTRACT

A system and method relating to object detection may include receiving an image frame comprising an array of pixels captured by an image sensor associated with the processing device, identifying a near-field image segment and a far-field image segment in the image frame, applying a first neural network trained for near-field image segments to the near-field image segment for detecting the objects presented in the near-field image segment, and applying a second neural network trained for far-field image segments to the far-field image segment for detecting the objects presented in the near-field image segment.

### CROSS-REFERENCE TO RELATED APPLICATION

This application claims priority to U.S. Provisional Application 62/711,695 filed Jul. 30, 2018, the content of which is incorporated by reference in its entirety.

### TECHNICAL FIELD

The present disclosure relates to detecting objects in images, and in particular, to a system and method for object detection using multiple neural networks trained for different fields of the images.

### BACKGROUND

Computer systems programmed to detect objects in an environment have wide industrial applications. For example, an autonomous vehicle may be equipped with sensors (e.g., Lidar sensor and video cameras) to capture sensor data surrounding the vehicle. Further, the autonomous vehicle may be equipped with a computer system including a processing device to execute executable code to detect the objects surrounding the vehicle based on the sensor data.

Neural networks are used in object detection. The neural networks in this disclosure are artificial neural networks which may be implemented using electrical circuits to make decisions based on input data. A neural network may include one or more layers of nodes, where each node may be implemented in hardware as a calculation circuit element to perform calculations. The nodes in an input layer may receive input data to the neural network. Nodes in an inner layer may receive the output data generated by nodes in a prior layer. Further, the nodes in the layer may perform certain calculations and generate output data for nodes of the subsequent layer. Nodes of the output layer may generate output data for the neural network. Thus, a neural network may contain multiple layers of nodes to perform calculations propagated forward from the input layer to the output layer.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system to detect objects using multiple compact neural networks matching different image fields according to an implementation of the present disclosure.

FIG. 2 illustrates the decomposition of an image frame according to an implementation of the present disclosure.

FIG. 3 illustrates the decomposition of an image frame into a near-field image segment and a far-field image segment according to an implementation of the present disclosure.

FIG. 4 depicts a flow diagram of a method to use the multi-field object detector according to an implementation of the present disclosure.

FIG. 5 depicts a block diagram of a computer system operating in accordance with one or more aspects of the present disclosure.

### DETAILED DESCRIPTION

A neural network may include multiple layers of nodes. The layers may include an input layer, an output layer, and hidden layers in-between. The calculations of the neural network are propagated from the input layer through the hidden layers to the output layer. Each layer may include nodes associated with node values calculated from a prior layer through edges connecting nodes between the present layer and the prior layer. Edges may connect the nodes in a layer to nodes in an adjacent layer. Each edge may be associated with a weight value. Therefore, the node values associated with nodes of the present layer can be a weighed summation of the node values of the prior layer.

One type of the neural networks is the convolutional neural networks (CNNs) where the calculation performed at the hidden layers can be convolutions of node values associated with the prior layer and weight values associated with edges. For example, a processing device may apply convolution operations to the input layer and generate the node values for the first hidden layer connected to the input layer through edges, and apply convolution operations to the first hidden layer to generate node values for the second hidden layer, and so on until the calculation reaches the output layer. The processing device may apply a soft combination operation to the output data and generate a detection result. The detection result may include the identities of the detected objects and their locations.

The topology and the weight values associated with edges are determined in a neural network training phase. During the training phase, training input data may be fed into the CNN in a forward propagation (from the input layer to the output layer). The output results of the CNN may be compared to the target output data to calculate an error data. Based on the error data, the processing device may perform a backward propagation in which the weight values associated with edges are adjusted according to a discriminant analysis. This process of forward propagation and backward propagation may be iterated until the error data meet certain performance requirements in a validation process. The CNN then can be used for object detection. The CNN may be trained for a particular class of objects (e.g., human objects) or multiple classes of objects (e.g., cars, pedestrians, and trees).

Autonomous vehicles are commonly equipped with a computer system for object detection. Instead of relying on a human operator to detect objects in the surrounding environment, the onboard computer system may be programmed to use sensors to capture information of the environment and detect objects based on the sensor data. The sensors used by autonomous vehicles may include video cameras, Lidar, radar etc.

In some implementations, one or more video cameras are used to capture the images of the surrounding environment. The video camera may include an optical lens, an array of light sensing elements, a digital image processing unit, and a storage device. The optical lens may receive light beams and focus the light beams on an image plane. Each optical lens may be associated with a focal length that is the distance between the lens and the image plane. In practice, the video camera may have a fixed focal length, where the focal length may determine the field of view (FOV). The field of view of an optical device (e.g., the video camera) refers to an observable area through the optical device. A shorter focal length may be associated with a wider field of view; a longer focal length may be associated with a narrower field of view.

The array of light sensing elements may be fabricated in a silicon plane situated at a location along the optical axis of the lens to capture the light beam passing through the lens. The image sensing elements can be charge-coupled devices (CCD) elements, complementary metal-oxide-semiconductor (CMOS) elements, or any suitable types of light sensing devices. Each light sensing element may capture different color components (red, green, blue) of the light shined on the light sensing element. The array of light sensing elements can include a rectangular array of pre-determined number of elements (e.g., M by N, where M and N are integers). The total number of elements in the array may determine the resolution of the camera.

The digital image processing unit is a hardware processor that may be coupled to the array of light sensing elements to capture the responses of these light sensing elements to light. The digital image processing unit may include an analog-to-digital converter (ADC) to convert the analog signals from the light sensing elements to digital signals. The digital image processing unit may also perform filter operations on the digital signals and encode the digital signals according to a video compression standard.

In one implementation, the digital image processing unit may be coupled to a timing generator and record images captured by the light sensing elements at a pre-determined time intervals (e.g., 30 or 60 frames per second). Each recorded image is referred to as an image frame including a rectangular array of pixels. Thus, the image frames captured by a fixed-focal video camera at a fixed spatial resolutions can be stored in the storage device for further processing such as, for example, object detection, where the resolution is defined by the number of pixels in a unit area in an image frame.

One technical challenge for autonomous vehicles is to detect human objects based on images captured by one or more video cameras. Neural networks can be trained to identify human objects in the images. The trained neural networks may be deployed in real operation to detect human objects. If the focal length is much shorter than the distance between the human object and the lens of the video camera, the optical magnification of the video camera can be represented as G=f/p=i/o, where p is the distance from the object to the center of the lens, f is the focal length, i (measured in number of pixels) is the length of an object projected on the image frame, and o is the height of the object. As the distance p increases, the number of pixels associated with the object decreases. As a result, fewer pixels are employed to capture the height of a human object at faraway. Because fewer pixels may provide less information about the human object, it may be difficult for the trained neural networks to detect faraway human objects. For example, assume that focal length f=0.1 m (meters); object height o=2 m; pixel density k=100 pixels/mm; minimum number of pixels for object detection Nₘᵢₙ=80 pixels. The maximum distance for reliable object detection is p=f*o/(N/k)=0.1*2/80*10⁻³/100=250 m. Thus, the field depths beyond 250 m is defined as the far field. If i=40 pixels, then p=500 m. If a far-field is in the range of 250-500 m, the resolution used to represent the object needs to be doubled from 40 pixels to 80 pixels.

To overcome the above-identified and other deficiencies of object detection using neural networks, implementations of the present disclosure provide a system and method that may divide the two-dimensional region of the image frame into image segments. Each image segment may be associated with a specific field of the image including at least one of a far field or a near field. The image segment associated with the far field may have a higher resolution than the image segment associated with the near field. Thus, the image segment associated with the far field may include more pixels than the image segment associated with the near field. Implementations of the disclosure may further provide each image segment with a neural network that is specifically trained for the image segment, where the number of neural networks is the same as the number of image segments. Because each image segment is much smaller than the whole image frame, the neural networks associated with the image segments are much more compact and may provide more accurate detection results.

Implementations of the disclosure may further track the detected human object through different segments associated with different fields (e.g., from the far field to the near field) to further reduce the false alarm rate. When the human object moves into the range of a Lidar sensor, the Lidar sensor and the video camera may be paired together to detect the human object.

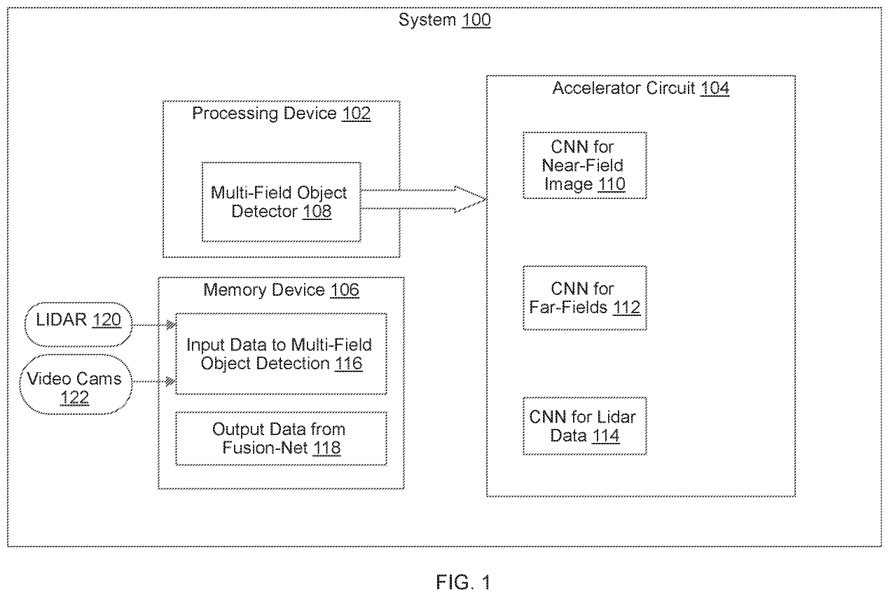

FIG. 1 illustrates a system 100 to detect objects using multiple compact neural networks matching different image fields according to an implementation of the present disclosure. As shown in FIG. 1, system 100 may include a processing device 102, an accelerator circuit 104, and a memory device 106. System 100 may optionally include sensors such as, for example, Lidar sensors 122 and video cameras 120. System 100 can be a computing system (e.g., a computing system onboard autonomous vehicles) or a system-on-a-chip (SoC). Processing device 102 can be a hardware processor such as a central processing unit (CPU), a graphic processing unit (GPU), or a general-purpose processing unit. In one implementation, processing device 102 can be programmed to perform certain tasks including the delegation of computationally-intensive tasks to accelerator circuit 104.

Accelerator circuit 104 may be communicatively coupled to processing device 102 to perform the computationally-intensive tasks using the special-purpose circuits therein. The special-purpose circuits can be an application specific integrated circuit (ASIC), a field programmable gate array (FPGA), a digital signal processor (DSP), network processor, or the like. In one implementation, accelerator circuit 104 may include multiple calculation circuit elements (CCEs) that are units of circuits that can be programmed to perform a certain type of calculations. For example, to implement a neural network, CCE may be programmed, at the instruction of processing device 102, to perform operations such as, for example, weighted summation and convolution. Thus, each CCE may be programmed to perform the calculation associated with a node of the neural network; a group of CCEs of accelerator circuit 104 may be programmed as a layer (either visible or hidden layer) of nodes in the neural network; multiple groups of CCEs of accelerator circuit 104 may be programmed to serve as the layers of nodes of the neural networks. In one implementation, in addition to performing calculations, CCEs may also include a local storage device (e.g., registers) (not shown) to store the parameters (e.g., synaptic weights) used in the calculations. Thus, for the conciseness and simplicity of description, each CCE in this disclosure corresponds to a circuit element implementing the calculation of parameters associated with a node of the neural network. Processing device 102 may be programmed with instructions to construct the architecture of the neural network and train the neural network for a specific task.

Memory device 106 may include a storage device communicatively coupled to processing device 102 and accelerator circuit 104. In one implementation, memory device 106 may store input data 116 to a multi-field object detector 108 executed by processing device 102 and output data 118 generated by the multi-field object detector 108. The input data 116 can be sensor data captured by sensors such as, for example, Lidar sensor 120 and video cameras 122. Output data can be object detection results made by multi-field object detector 108. The objection detection results can be the identification of human objects.

In one implementation, processing device 102 may be programmed to execute multi-field object detector 108 that, when executed, may detect human objects based on input data 116. Instead of utilizing a neural network that detects objects based on a full-resolution image frame captured by video cameras 122, implementations of multi-field object detector 108 may employ the combination of several reduced-complexity neural networks to achieve object detection. In one implementation, multi-field object detector 108 may decompose video images captured by video camera 122 into a near-field image segment and a far-field image segment, where the far-field image segment may have a higher resolution than the near-field image segment. The size of either the far-field image segment or the near-field image segment is smaller than the size of the full-resolution image. Multi-field object detector 108 may apply a convolutional neural network (CNN) 110, specifically trained for the near-field image segment, to the near-field image segment, and apply a CNN 112, specifically-trained for the far-field image segment, to the far-field image segment. Multi-field object detector 108 may further track the human objected detected in the far-field through time to the near-field until the human object reaches the range of Lidar sensor 120. Multi-field object detector 108 may then apply a CNN 114, specifically-trained for Lidar data, to the Lidar data. Because CNNs 110, 112 are respectively trained for near-field image segments and far-field image segments, CNN 110, 112 can be compact CNNs that are smaller than the CNN trained for the full-resolution image.

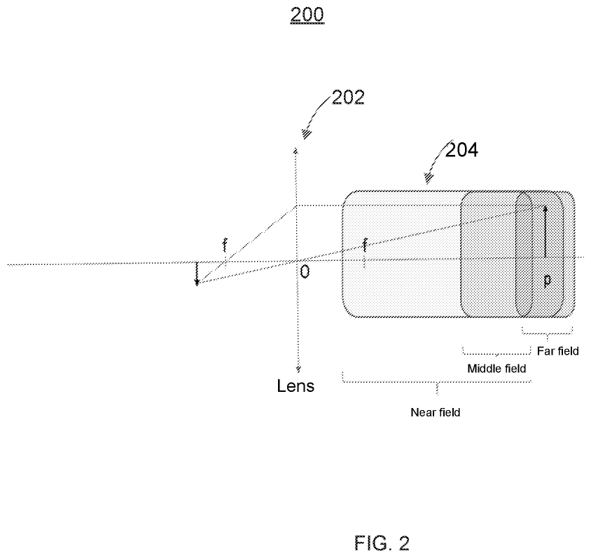

Multi-field object detector 108 may decompose a full-resolution image into a near-field image representation (referred to as the “near-field image segment”) and a far-field image representation (referred to as the “far-field image segment”), where the near-field image segment captures objects closer to the optical lens and the far-field image segment captures objects far away from the optical lens. FIG. 2 illustrates the decomposition of an image frame according to an implementation of the present disclosure. As shown in FIG. 2, the optical system of a video camera 200 may include a lens 202 and an image plane (e.g., the array of light sensing elements) 204 at a distance from the lens 202, where the image plane is within the depth of field of the video camera. The depth of field is the distance between the image plane and the plane of focus where objects captured on the image plane appear acceptably sharp in the image. Objects that are far away from lens 202 may be projected to a small region on the image plane, thus requiring higher resolution (or sharper focus, more pixels) to be recognizable. In contrast, objects that are near lens 202 may be projected to a large region on the image plane, thus requiring lower resolution (fewer pixels) to be recognizable. As shown in FIG. 2, the near-field image segment covers a larger region than the far-field image segment on the image plane. In some situations, the near-field image segment can overlap with a portion of the far-field image on the image plane.

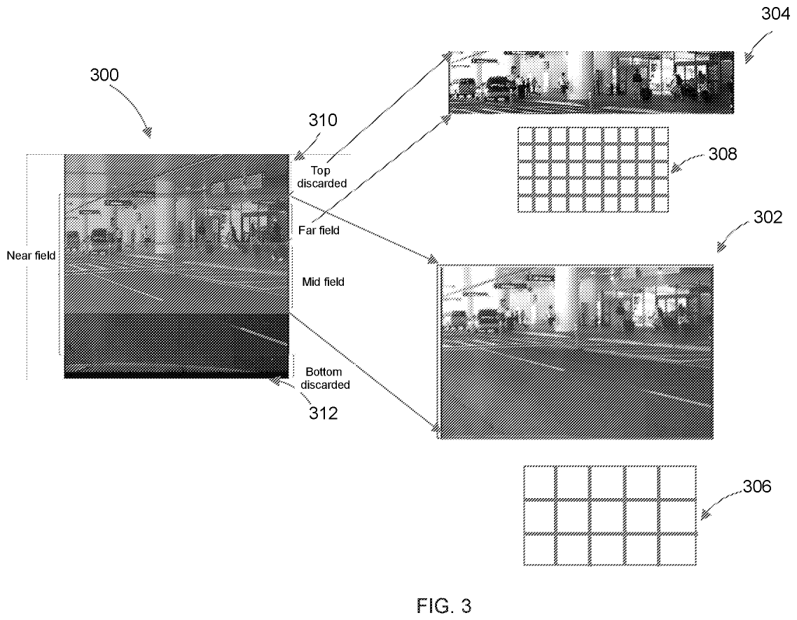

FIG. 3 illustrates the decomposition of an image frame 300 into a near-field image segment 302 and a far-field image segment 304 according to an implementation of the present disclosure. Although above implementations are discussed using near-field image segments and far-field image segments as an example, implementations of the disclosure may also include multiple fields of image segments, where each of the image segments is associated with a specifically-trained neural network. For example, the image segments may include a near-field image segment, a mid-field image segment, and a far-field image segment. The processing device may apply different neural networks to the near-field image segment, the mid-field image segment, and the far-field image segment for human object detection.

Video camera may record a stream of image frames including an array of pixels corresponding to the light sensing elements on image plane 204. Each image frame may include multiple rows of pixels. The area of the image frame 300 is thus proportional to the area of image plane 204 as shown in FIG. 2. As shown in FIG. 3, near-field image segment 302 may cover a larger portion of the image frame than the far-field image segment 304 because objects close to the optical lens are projected bigger on the image plane. In one implementation, the near-field image segment 304 and the far-field image segment 306 may be extracted from the image frame, where the near-field image segment 302 is associated with a lower resolution (e.g., a sparse sampling pattern 306) and the far-field image segment 304 is associated with a higher resolution (e.g., a dense sampling pattern 308).

In one implementation, processing device 102 may execute an image preprocessor to extract near-field image segment 306 and far-field image segment 308. Processing device 102 may first identify a top band 310 and a bottom band 312 of the image frame 300, and discard the top band 310 and bottom band 312. Processing device 102 may identify top band 310 as a first pre-determined number of pixel rows and bottom band 312 as a second pre-determined number of pixel rows. Processing device 102 can discard top band 310 and bottom band 312 because these two bands cover the sky and road right in front of the camera and these two bands commonly do not contain human objects.

Processing device 102 may further identify a first range of pixel rows for the near-field image segment 302 and a second range of pixel rows for the far-field image segment 304, where the first range can be larger than the second range. The first range of pixel rows may include a third pre-determined number of pixel rows in the middle of the image frame; the second range of pixel rows may include a fourth pre-determined number of pixel rows vertically above the center line of the image frame. Processing device 102 may further decimate pixels within the first range of pixel rows using a sparse subsampling pattern 306, and decimate pixels within the second range of pixel rows using a dense subsampling pattern 308. In one implementation, the near-field image segment 302 is decimated using a large decimation factor (e.g., 8) while far-field image segment 304 is decimated using a small decimation factor (e.g., 2), thus resulting in the extracted far-field image segment 304 at a higher resolution than the extracted near-field image segment 306. In one implementation, the resolution of far-field image segment 304 can be twice the resolution of the near-field image segment 306. In another implementation, the resolution of far-field image segment 304 can be more than double the resolution of the near-field image segment 306.

Video camera may capture a stream of image frames at a certain frame rate (e.g., 30 or 60 frames per second). Processing device 102 may execute the image preprocessor to extract a corresponding near-field image segment 302 and far-field image segment 304 for each image frame in the stream. In one implementation, a first neural network is trained based on near-field image segment data, and a second neural network is trained based on far-field image segment data both for human object detection. The numbers of nodes in the first neural network and the second neural network are small compared to a neural network trained for the full resolution of the image frame.

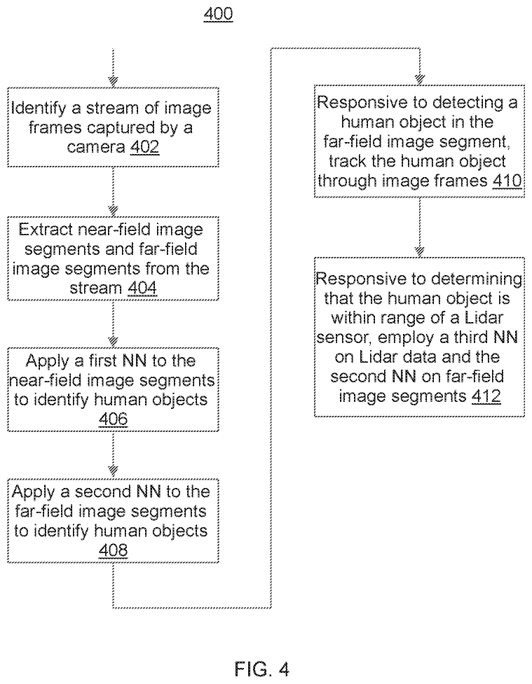

FIG. 4 depicts a flow diagram of a method 400 to use the multi-field object detector according to an implementation of the present disclosure. Method 400 may be performed by processing devices that may comprise hardware (e.g., circuitry, dedicated logic), computer readable instructions (e.g., run on a general purpose computer system or a dedicated machine), or a combination of both. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by a processing device 102 executing multi-field object detector 108 and accelerator circuit 104 supporting CNNs as shown in FIG. 1.

The compact neural networks for human object detection may need to be trained prior to being deployed on autonomous vehicles. During the training processing, the weight parameters associated with edges of the neural networks may be adjusted and selected based on certain criteria. The training of neural networks can be done offline using publicly available databases. These publicly available databases may include images of outdoor scenes including human objects that have been manually labeled. In one implementation, the images of training data may be further processed to identify human objects in the far-field and in the near-field. For example, the far-field image may be a 50×80 pixel window cropped out of the images. Thus, the training data may include far-field training data and near-field training data. The training can be done by a more powerful computer offline (referred to as the “training computer system”)

The processing device of the training computer system may train a first neural network based on the near-field training data and train a second neural network based on the far-field training data. The type of neural networks can be convolutional neural networks (CNNs), and the training can be based on backward propagation. The trained first neural network and the second neural network are small compared to a neural network trained based on the full resolution of the image frame. After training, the first neural network and the second neural network can be used by autonomous vehicles to detect objects (e.g., human objects) on the road.

Referring to FIG. 4, at 402, processing device 102 (or a different processing device onboard an autonomous vehicle) may identify a stream of image frames captured by a video camera during the operation of the autonomous vehicle. The processing device is to detect human objects in the stream.

At 404, processing device 102 may extract near-field image segments and far-field image segments from the image frames of the stream using the method describe above in conjunction with FIG. 3. The near-field image segments may have a lower resolution than that of the far-field image segments.

At 406, processing device 102 may apply the first neural network, trained based on the near-field training data, to the near-field image segments to identify human objects in the near-field image segments.

At 408, processing device 102 may apply the second neural network, trained based on the far-field training data, to the far-field image segments to identify human objects in the far-field image segments.

At 410, responsive to detecting a human object in a far-field image segment, processing device 102 may log the detected human object in a record, and track the human object through image frames from the far-field to the near-field. Processing device 102 may use polynomial fitting and/or Kalman predictors to predict the locations of the detected human object in subsequent image frames, and apply the second neural network to the far-field image segments extracted from the subsequent image frames to determine whether the human object is at the predicted location. If the processing device determines that the human object is not present at the predicted location, the detected human object is deemed a false alarm and removes the entry corresponding to the human object from the record.

At 412, processing device 102 may further determine whether the approaching human object is within the range of a Lidar sensor that is paired with the video camera on the autonomous vehicle for human object detection. The Lidar may detect an object in a range that is shorter than the far-field but within the near-field. Responsive to determining that the human object is within the range of the Lidar sensor (e.g., by detecting an object in the corresponding location with the far-field image segment), processing device may apply a third neural network trained for Lidar sensor data to the Lidar sensor data and apply the second neural network for the far-field image segment (or the first neural network for the near-field image segment). In this way, the Lidar sensor data may be used in conjunction with the image data for further improving human object detection.

Processing device 102 may further operate the autonomous vehicle based on the detection of human objects. For example, processing device 102 may operate the vehicle to stop or avoid collision with the human objects.

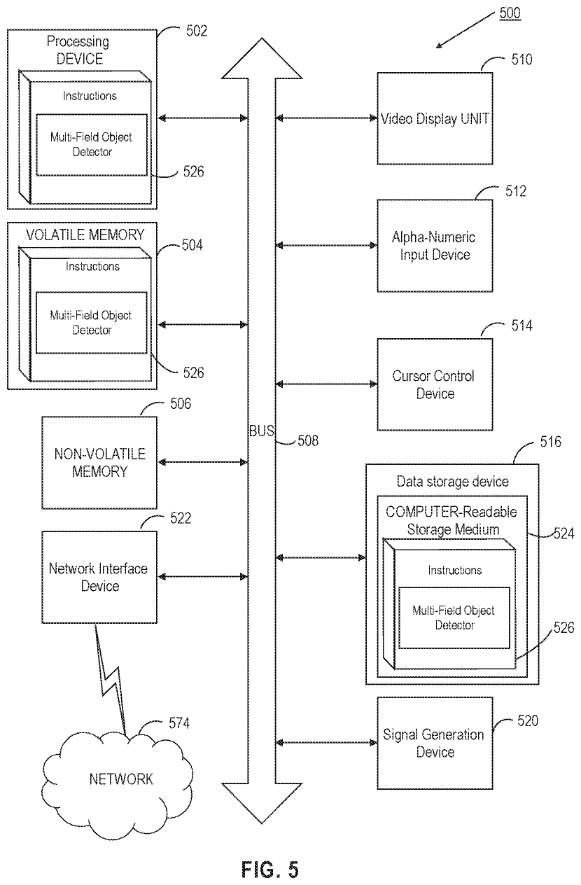

FIG. 5 depicts a block diagram of a computer system operating in accordance with one or more aspects of the present disclosure. In various illustrative examples, computer system 500 may correspond to the system 100 of FIG. 1.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions of the multi-field object detector 108 of FIG. 1 for implementing method 400.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method for detecting objects using multiple sensor devices, comprising:
receiving, by a processing device, an image frame comprising an array of pixels captured by an image sensor associated with the processing device;
identifying, by the processing device, a near-field image segment and a far-field image segment in the image frame;
applying, by the processing device, a first neural network trained for near-field image segments to the near-field image segment for detecting objects presented in the near-field image segment; and
applying, by the processing device, a second neural network trained for far-field image segments to the far-field image segment for detecting objects presented in the far-field image segment.

2. The method of claim 1, wherein each of the near-field image segment or the far-field image segment comprises fewer pixels than the image frame.

3. The method of claim 1, wherein the near-field image segment comprises a first number of rows of pixels and the far-field image comprises a second number of rows of pixels, and wherein the first number of rows of pixels is smaller than the second number of rows of pixels.

4. The method of claim 1, wherein a number of pixels of the near-field image segment is fewer than a number of pixels of the far-field image segment.

5. The method of claim 1, wherein a resolution of the near-field image segment is lower than a resolution of the far-field image segment.

6. The method of claim 1, wherein the near-field image segment captures a scene at a first distance to an image plane of the image sensor, and the far-field image segment captures a scene at a second distance to the image plane, and wherein the first distance is smaller than the second distance.

7. The method of claim 1, further comprising:
responsive to at least one of identifying a first object in the near-field image or identifying a second object in the far-field image segment, operating an autonomous vehicle based on detection of the first object or the second object.

8. The method of claim 1, further comprising:
responsive to detecting a second object in the far-field image segment, tracking the second object over time through a plurality of image frames from a range associated with the far-field image segment to a range associated with one of the near-field image segment or the far-field image segment;
determining that the second object in a second image frame reaches a range of a Lidar sensor based on tracking the second object over time;
receiving Lidar sensor data captured by the Lidar sensor; and
applying a third neural network trained to the Lidar sensor data to detect the objects.

9. The method of claim 8, further comprising:
applying the first neural network to the near-field image segment of the second image frame, or applying the second neural network to the far-field image segment of the second image frame; and
validating an object detected by at least one of applying the first neural network or applying the second neural network with the object detected by applying the third neural network.

10. A system for detecting objects using multiple sensor devices, comprising:
an image sensor;
a storage device for storing instructions; and
a processing device, communicatively coupled to the image sensor and the storage device, for executing the instructions to:
receive an image frame comprising an array of pixels captured by the image sensor associated with the processing device;
identify a near-field image segment and a far-field image segment in the image frame;
apply a first neural network trained for near-field image segments to the near-field image segment for detecting objects presented in the near-field image segment; and
apply a second neural network trained for far-field image segments to the far-field image segment for detecting objects presented in the far-field image segment.

11. The system of claim 10, wherein each of the near-field image segment or the far-field image segment comprises fewer pixels than the image frame.

12. The system of claim 10, wherein the near-field image segment comprises a first number of rows of pixels and the far-field image comprises a second number of rows of pixels, and wherein the first number of rows of pixels is smaller than the second number of rows of pixels.

13. The system of claim 10, wherein a number of pixels of the near-field image segment is fewer than a number of pixels of the far-field image segment.

14. The system of claim 10, wherein a resolution of the near-field image segment is lower than a resolution of the far-field image segment.

15. The system of claim 10, wherein the near-field image segment captures a scene at a first distance to an image plane of the image sensor, and the far-field image segment captures a scene at a second distance to the image plane, and wherein the first distance is smaller than the second distance.

16. The system of claim 10, wherein the processing device is to:
responsive to at least one of identifying a first object in the near-field image or identifying a second object in the far-field image segment, operate an autonomous vehicle based on detection of the first object or the second object.

17. The system of claim 10, further comprising a Lidar sensor, wherein the processing device is to:
responsive to detecting a second object in the far-field image segment, track the second object over time through a plurality of image frames from a range associated with the far-field image segment to a range associated with one of the near-field image segment or the far-field image segment;
determine that the second object in a second image frame reaches a range of the Lidar sensor based on tracking the second object over time;
receive Lidar sensor data captured by the Lidar sensor; and
apply a third neural network trained to the Lidar sensor data to detect the objects.

18. The system of claim 17, wherein the processing device is to:
apply the first neural network to the near-field image segment of the second image frame, or apply the second neural network to the far-field image segment of the second image frame; and
validate an object detected by at least one of applying the first neural network or applying the second neural network with the object detected by applying the third neural network.

19. A non-transitory machine-readable storage medium storing instructions which, when executed, cause a processing device to perform operations for detecting objects using multiple sensor devices, the operations comprising:
receiving, by the processing device, an image frame comprising an array of pixels captured by an image sensor associated with the processing device;
identifying, by the processing device, a near-field image segment and a far-field image segment in the image frame;
applying, by the processing device, a first neural network trained for near-field image segments to the near-field image segment for detecting objects presented in the near-field image segment; and
applying, by the processing device, a second neural network trained for far-field image segments to the far-field image segment for detecting objects presented in the far-field image segment.

20. The non-transitory machine-readable storage medium of claim 19, wherein the near-field image segment comprises a first number of rows of pixels and the far-field image comprises a second number of rows of pixels, and wherein the first number of rows of pixels is smaller than the second number of rows of pixels.
